(19) United States
(12) Patent Application Publication
(10) Pub. No.: US 2012/0324625 A1
(43) Pub. Date: Dec. 27, 2012

(54) REUSABLE STRAPLESS LACE MASQUERADE

(76) Inventor: Stephanie Hair, Los Angeles, CA (US)

(21) Appl. No.: 13/168,845

(22) Filed: Jun. 24, 2011

(51) Int. Cl. A42B 1/00; B32B 37/12; B32B 38/10; B32B 3/10; B32B 3/24

(52) U.S. Cl. 2/206; 428/195.1; 428/196; 428/137; 156/250; 156/326

(57) ABSTRACT

The present invention provides a reusable masquerade formed of delicate or fragile material that can be retained to skin surface without straps/bands through a backing and adhesive. Suitable delicate materials may include lace, embroidery, brocade, crochet, netting, fishnet, mesh, tissue paper, sequins, beads, and filigree. The backing is applied to the delicate material by ironing, heating, or melting it on. Suitable backing materials may include vinyl, rubber, and plastic. The periphery of the masquerade comprising the delicate material together with attached backing is precisely cut to at least partially conform to a design on the delicate material and to conform to an anatomy of a target skin surface on which it is placed. The masquerade may be placed on the face with a hole for the eye in it. It can be worn again as the adhesive is easily removed from the backing and skin with conventional means.

BACKGROUND

1. Field of the Invention

The present invention relates to the fields of masks, masquerades, disguises, appliqués, decals, tattoos, and face or body art or apparel. More specifically, the present invention relates to reusable masquerades. Most specifically, the present invention relates to reusable masquerades fabricated from delicate materials that can be comfortably worn without straps or bands.

2. Description of the Related Art

Modern popular and alternative fashion and culture have made it stylish to wear body art. Body art may take several forms depending upon the intention and environment of the model. For everyday use appliqués, decals, and tattoos are common. For special occasions including attending concerts, masquerade or costume parties, proms, dances, discos, Halloween, and the like, masks, masquerades, and disguises become more acceptable and appropriate. For example, as a major pop culture icon Lady Gaga has catalyzed a renaissance of masquerades and endorsed lace as a fashion statement. Encouraging people to discover and express their individuality is part of her mantra. In doing so Gaga's voluminous fan base of “little monsters” (a term she affectionately uses to refer to her followers) frequently adorn themselves in a like manner at least when attending her shows. Other common examples of those who would wear masquerades are individuals going for a Steampunk, Cyberpunk, Gothic, Romantic, or Victorian style or effect.

Traditional masks, masquerades, and disguises for the face typically require a band or strap behind the head that holds them to the face. This band or strap can be irritating or annoying to a wearer and limits hair style options. It would be desirable to provide a masquerade without a strap around the head. One alternative to a band or strap that holds the mask in position is to use an adhesive. However, adhesives can make the mask a one-time product and can be especially difficult to use with masks fabricated from delicate and fine materials. It would be desirable to provide a masquerade fabricated from delicate and fine materials that is attachable to the skin with adhesive without damaging the masquerade so that it may be reused or worn again.

Currently available strapless body art that is retained to the skin through adhesive is frequently not reusable or has limited reusability because the adhesive is directly on the decal or appliqué and wears out over time. It would be desirable to provide body art that can be retained to the skin through adhesive and is reusable.

Currently available strapless body art that is retained to the skin through a separate adhesive that is applied to the back of the decal or appliqué can be messy. This process is poorly suited for direct application to delicate materials with intricate weaves and ornamentation within which the adhesive residue can become embedded and entangled. Such delicate materials include lace, embroidery, and the like. Applying adhesive directly to many materials creates residue buildup over time and can be difficult to remove completely without damaging the appliqué. It would be desirable to provide a decal, appliqué, or masquerade formed of a delicate material that can be applied with an adhesive that does not damage the delicate material or create residue buildup after removal on the back of the appliqué.

The present invention solves these and other needs.

### SUMMARY OF THE INVENTION

Provided herein is a fashion-forward reusable strapless masquerade fabricated from a delicate material that can be retained to the skin with adhesive. The reusable masquerades described herein can be safely applied to the skin with a conventional skin-safe adhesive, e.g. spirit gum, used in theater and film industries. The delicate material may be, but is not limited to, any one or more of the following: lace, embroidery, brocade, crochet, netting, fishnet, mesh, tissue paper, sequins, beads, filigree, and the like. Retention of such delicate materials to the skin is achieved by providing a backing for the delicate material to which the adhesive may be applied and easily removed. The delicate material is preserved because the adhesive does not contact the delicate material directly but retains the delicate material to the skin indirectly through the backing The backing must be sufficiently fine and thin so as not to intrude upon or obstruct the effect of the design provided by the delicate material.

The delicate material may be precisely cut to follow a pattern on the lace, embroidery, brocade, etc. This precise cutting may be performed by hand or machine.

The backing is preferably secured to the delicate material by ironing it on. The backing may be made of vinyl or any other flexible material that can be secured to the delicate material without the use of messy adhesives. For example, the backing may be secured to the delicate material by sticking it on, then heating or applying energy, e.g. by ironing it on.

These masquerades in accordance with the present invention may be worn for theme parties, costume parties, dances, and by performing musicians and fans or for roles by actors and actresses.

According to one of several aspects the present invention provides a reusable masquerade including a delicate material precisely cut in a manner that at least partially conforms to a design on the delicate material and a flexible backing on a surface of the delicate material. The delicate material may be any one or more of lace, embroidery, brocade, crochet, netting, fishnet, mesh, tissue paper, sequins, beads, and filigree. The flexible backing may be vinyl, rubber, or plastic. The flexible backing may be transparent. The flexible backing may be translucent. The flexible backing may be transparent vinyl. The flexible backing may be configured to adhere to skin through spirit gum and yet the spirit gum can be easily removed from the flexible backing with soap and water or a makeup remover. The flexible backing adheres to the delicate material by ironing the flexible backing onto the delicate material. The flexible backing may have a thickness that is less than 25% of the thickness of the delicate material. The reusable masquerade may have a hole in it sized and configured to fit over a person's eye and an outer periphery sized and configured for placement on a person's face around the eye.

According to another aspect the present invention provides a method of making a reusable masquerade having a delicate material precisely cut in a manner that at least partially conforms to a design on the delicate material and a flexible backing on a surface of the delicate material, the method involving the steps of positioning a material that will be used for the flexible backing adjacent the delicate material, adhering the flexible backing to the delicate material, and cutting the delicate material and attached flexible backing in a manner that at least partially conforms to a design on the delicate material. The positioning step may involve laying the material that will be used for the flexible backing over the delicate material. The adhering step may involve sticking the flexible backing on the delicate material and/or heating the material that will be used for the flexible backing while it is adjacent the delicate material. The adhering step may involve ironing the material that will be used for the flexible backing onto the delicate material.

According to another aspect the present invention provides a method of attaching a reusable masquerade to skin involving the steps of applying spirit gum to a surface of a flexible backing of the masquerade, joining a surface of the flexible backing having the spirit gum on it to the skin, and applying pressure to a surface of a delicate material from which the masquerade is formed.

According to another aspect the present invention provides a method of attaching a reusable masquerade to skin involving the steps of applying spirit gum to a skin surface, attaching a surface of a flexible backing of the masquerade to the skin surface having the spirit gum on it, and applying pressure to a surface of a delicate material from which the masquerade is formed.

### BRIEF DESCRIPTION OF THE DRAWINGS

FIG. 1 is a first embodiment of a reusable masquerade according to the present invention.

FIG. 2 is a first embodiment of a reusable masquerade according to the present invention as viewed from another perspective.

FIG. 3 is a second embodiment of a reusable masquerade according to the present invention.

FIG. 4 is a third embodiment of a reusable masquerade according to the present invention.

FIG. 5 is a fourth embodiment of a reusable masquerade according to the present invention.

FIG. 6 is a fifth embodiment of a reusable masquerade according to the present invention.

FIG. 7 shows the approximate thickness of the flexible backing relative to the delicate material.

FIG. 8 is a schematic diagram that illustrates a method of making the reusable masquerade in accordance with an embodiment of the present invention.

### DETAILED DESCRIPTION OF THE PREFERRED EMBODIMENTS

The present invention provides an improved masquerade that can be retained to the body without a strap/band, is reusable, and formed of a delicate material to create a desired effect. This effect may be considered graceful, refined, distinguished, enchanting, alluring, mysterious, feminine, Steampunk, Cyberpunk, Gothic, Romantic, Victorian, and the like depending upon the particular style of masquerade together with the overall costume.

A preferred material for the masquerade is lace which is well-suited because it is thin and vinyl backings can be easily ironed onto it. However, any of the following delicate materials may also be used: embroidery, brocade, crochet, netting, fishnet, mesh, tissue paper, sequins, beads, and filigree.

One preferred use for the reusable strapless masquerade of the present invention is on the face in a manner that frames the eye. The masquerade essentially forms a donut shape around the eye with the eye able to see through the donut hole. However, the inner and outer peripheries of the donut need not be round nor regular as for a true donut shape.

Another preferred use for the masquerade on the face is on the side of an eye between the outer edge of the eye and the hairline and vertically from the top of the cheek bone extending into the forehead. Such a piece may or may not include vertical extensions that drop down the cheek and horizontal extensions that extend across the forehead.

Another preferred use for the reusable strapless masquerade is on the chest below the neck and above the bust. However, the masquerade may be worn on any skin surface of the body.

The backing may be any film or sheet of material that can be adhered to the delicate material, is safe for wearing on the skin, and will bond with a spirit gum or other suitable skin-safe adhesive. The backing is preferably secured to the delicate material in a manner that preserves the integrity of the material and does not interfere with the intended visual effect. According to one embodiment, the backing may be secured to the delicate material by ironing it onto the delicate material. According to one embodiment, the backing is formed from a vinyl or a composition including a vinyl group. Desirable properties of vinyl that make it well-suited for this application are: optically clear, kink-resistant, resists “necking down” (constricting when pulled), and flexible. One exemplary vinyl material that may be used for the backing is IRON-ON VINYL, an adhesive available from Therm-O-Web (Wheeling, Ill.) [see http://www.thermowebonline.com/]. IRON-ON VINYL is a flexible, ultraviolet resistant, and water repellant material that protects fabrics, such as the delicate material to which it is applied in accordance with the present invention. Other suitable materials for the backing may be but are not limited to: allyls, acrylates, polypropylene, plastic, rubber, and the like.

The thickness of the backing is preferably less than 3 mm, less than 2 mm, less than 1 mm, less than 0.5 mm, or less than 0.25 mm so that it does not interfere with the intended impact of the masquerade, is lightweight, easily conforms to the surface contours of the body in a target area in which it is placed, does not significantly raise the masquerade above the surface of the skin, and is comfortable to wear. Another manner of expressing the thickness of the backing is as a percentage of the thickness of the delicate material. Using this metric, the thickness of the backing is preferably less than 25% of the thickness of the delicate material. In many embodiments the thickness of the backing may be less than 15%, less than 10%, or less than 5% the thickness of the delicate material. According to one embodiment, the backing is transparent so that the skin can be seen through any spaces in the delicate material. According to another embodiment, the backing is translucent. The backing may also be skin colored or any other color depending upon the intended artistic effect.

In a method of making the reusable masquerade the flexible backing must be adhered to the delicate material. This can be accomplished by first cutting out a piece of vinyl that substantially matches but is preferably slightly larger than the piece of delicate material to which it is applied. According to one embodiment, one side of the vinyl is sticky or with an adhesive surface like a sticker. This sticky side is attached to the delicate material (e.g., lace fabric). Next, a heat-safe paper is placed between a conventional iron (e.g., for ironing clothes) and the vinyl. Then, using the conventional iron on the medium-high setting (for cotton fabric) after the iron warms up the hot iron is held directly on the heat-safe paper above the vinyl for 4-12 seconds, 6-10 seconds, or preferably 8 seconds. Next, the delicate material (e.g., lace fabric) is flipped over so that it is facing up. The iron is then placed directly on the surface of the delicate material (without heat-safe paper) for 1-7 seconds, 3-5 seconds, or preferably 4 seconds. Once the delicate material and vinyl backing cools they can be cut into the desired shape (e.g. to partially match a design on a surface of the delicate material) with scissors or by a machine. For mass production, the machine should be pre-programmed to slice the desired shape from a section or square of delicate material adhered to a flexible backing (e.g. vinyl).

After the backing is applied to the delicate material both can be precisely cut simultaneously to at least partially conform to a design, pattern, or shape on the delicate material or to conform to an anatomy at a target skin surface where the masquerade is to be applied. For example, if the delicate material is lace with a flower pattern the masquerade may be precisely cut along the border of the flowers, leaves, and stems. Or, if the target skin surface for the masquerade is on the face over the eye then the masquerade should be precisely cut with a hole in the center for the eye and leaving panels or an area around the eye that will fit on the face. Alternatively, a hole could be cut in the backing material but not in the lace before applying the backing material to the lace so that just the lace could be placed over the eye with the backing material and adhesive on it holding the masquerade to facial skin around the eye.

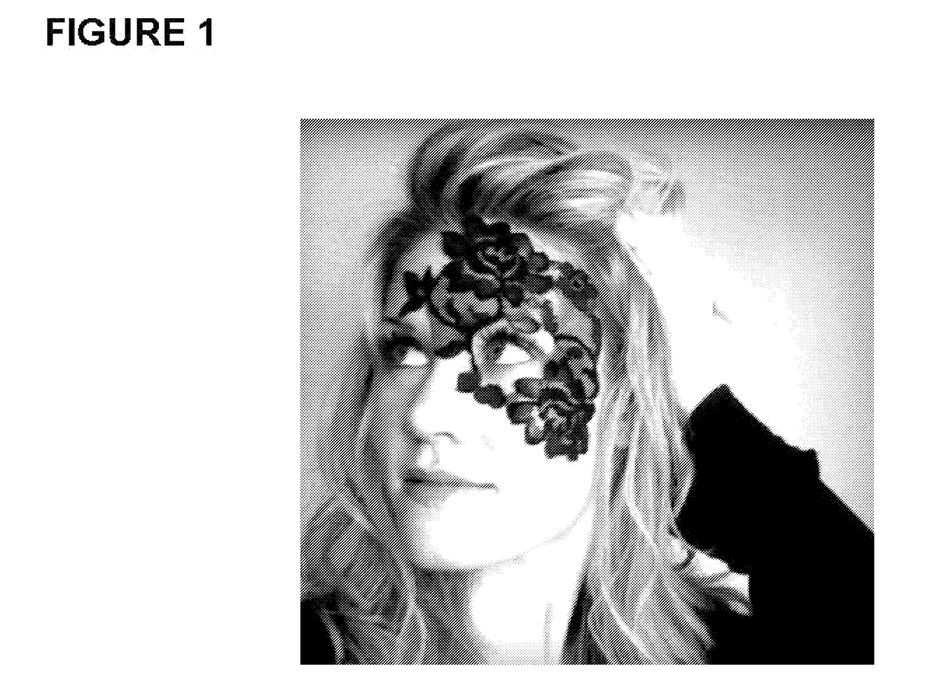

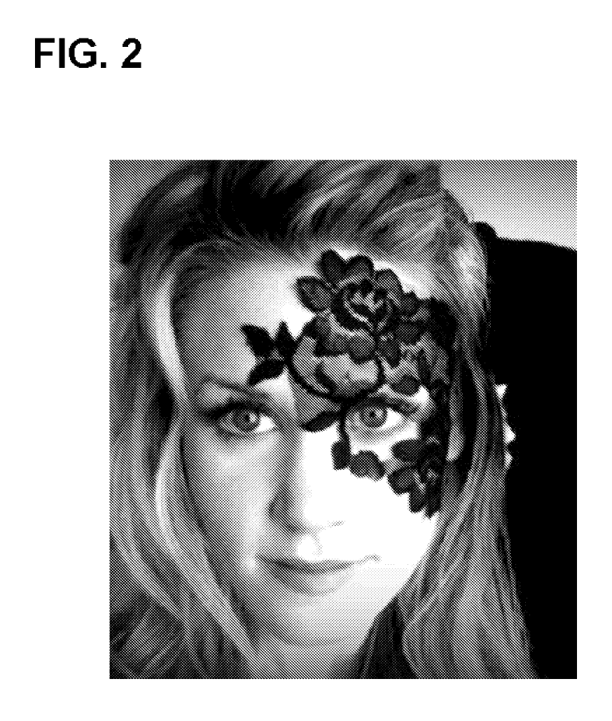

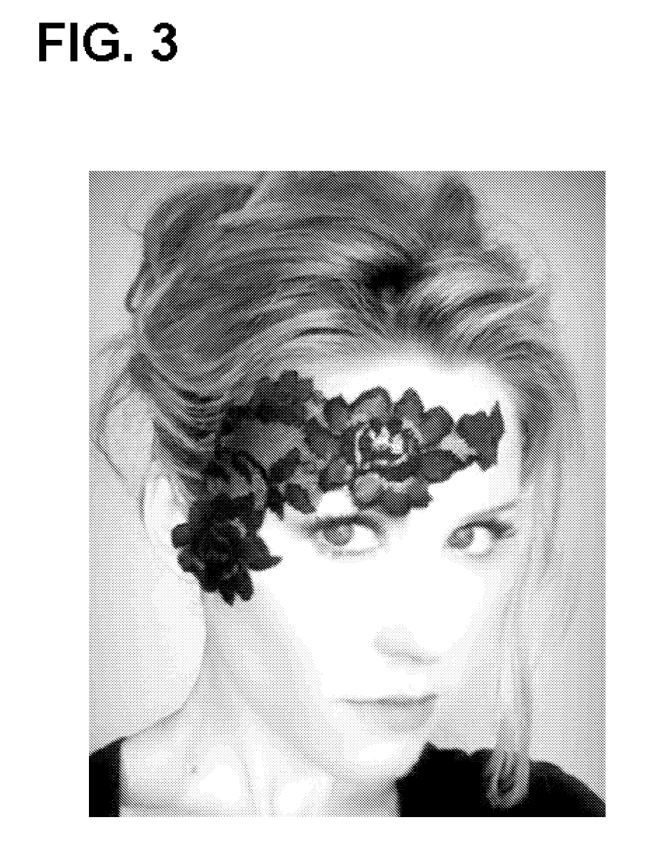

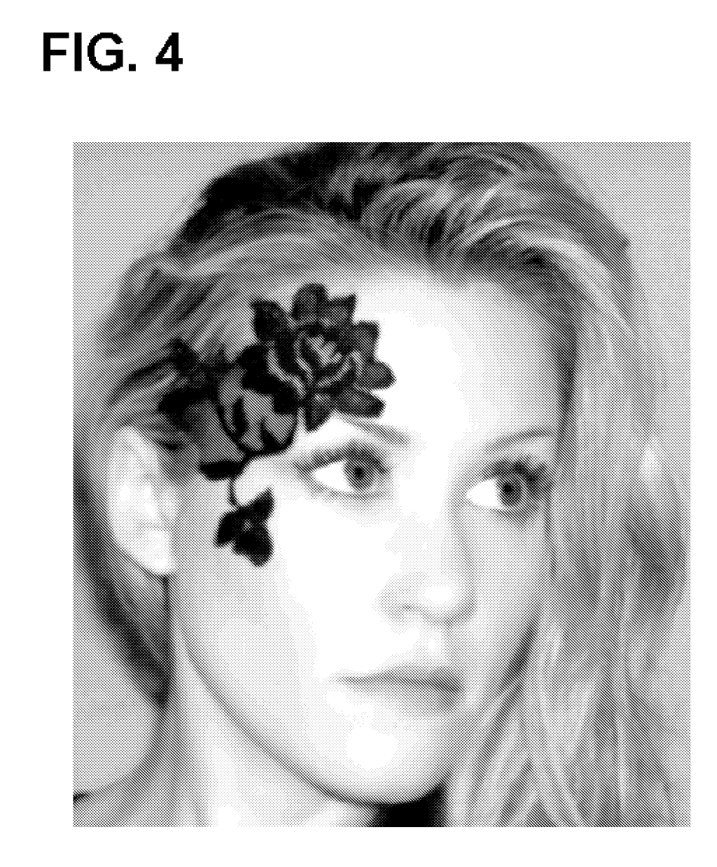

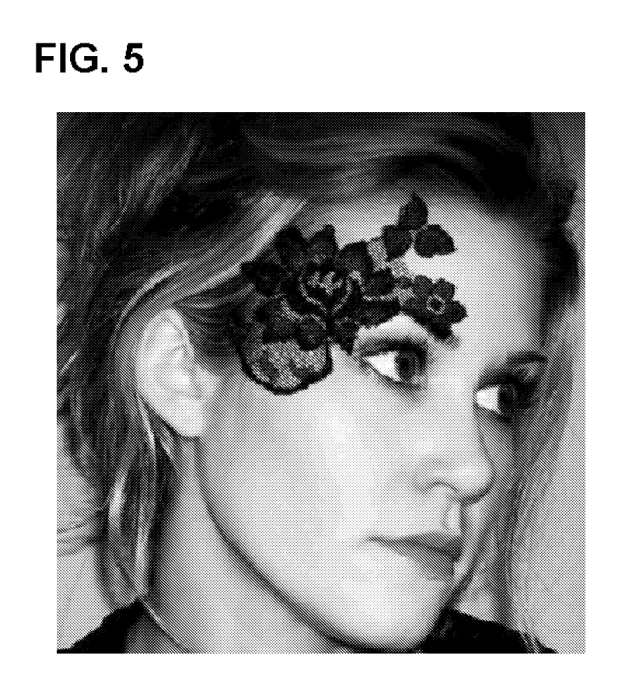

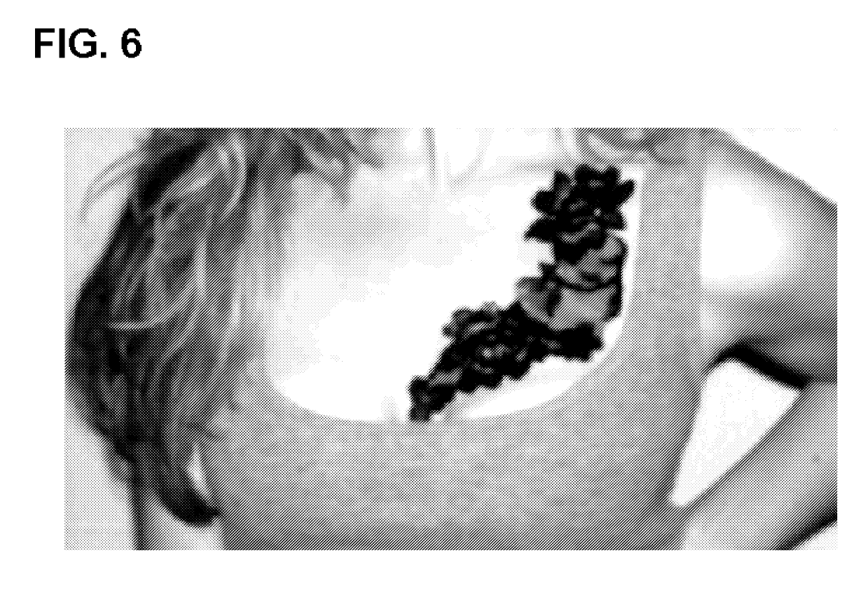

While the present invention is not limited to the specific designs and materials disclosed herein and the masquerade pieces may be custom made, FIGS. 1-6 illustrate several embodiments of the reusable masquerade in accordance with the present invention. FIGS. 1 and 2 show a first embodiment of the masquerade in which it frames the eye with a hole for the eye near the center of the masquerade. FIG. 3 shows a second embodiment of the masquerade in which it is substantially L-shaped extending vertically down one side of the face alongside the eye and horizontally partially across the forehead from the side of the face. FIG. 4 and FIG. 5 show two different yet similar third and fourth embodiments in which the masquerade rests on the side of the eye between the outer edge of the eye and the hairline, extending above one of the eyebrows. The third embodiment of FIG. 4 also has a piece that drops down extending over the top of the cheek bone. FIG. 6 shows a fifth embodiment that rests on the chest below the neck and above the bust. As shown, the fifth embodiment may be substantially L-shaped and worn with one arm of the L extending vertically along the inside of a tank top and the other arm of the L extending horizontally just above the bust. Other embodiments not shown are foreseeable and within the scope of the present invention. The number of possible designs is limitless.

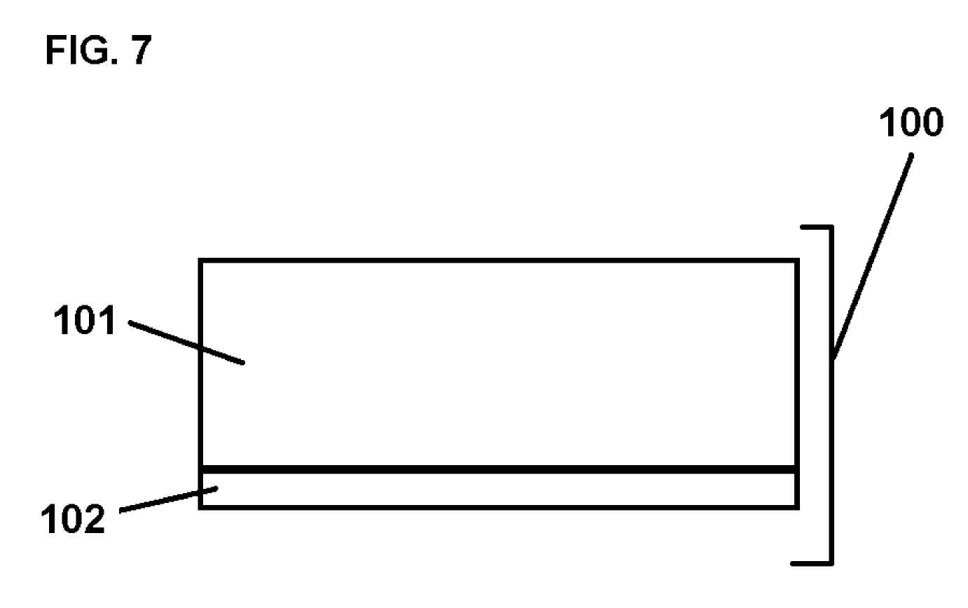

FIG. 7 shows a reusable masquerade 100 and illustrates the relative thickness of the backing 102 relative to the delicate material 101. The thickness of the backing is preferably no more than 25% the thickness of the delicate material.

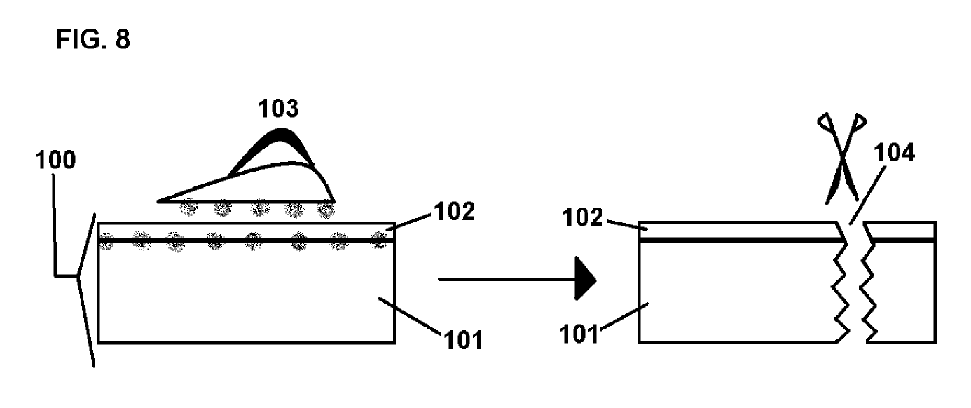

FIG. 8 shows the process of making the masquerade 100 by ironing 103 the flexible backing material 102 onto the delicate material 101 so that they adhere to each other and then cutting 104 the backing material and delicate material at the same time. Cutting should be performed in a precise manner such that the edges of the cutline at least partially conform to a design or pattern on the surface of the delicate material.

It will also be apparent from the foregoing that while particular forms of the invention have been illustrated and described, various modifications can be made without departing from the spirit and scope of the invention. Accordingly, it is not intended that the invention be limited, except as by the appended claims.

What is claimed is:

1. A reusable masquerade comprising a delicate material precisely cut in a manner that at least partially conforms to a design on the delicate material and a flexible backing on a surface of the delicate material.

2. The reusable masquerade of claim 1, wherein the delicate material is lace.

3. The reusable masquerade of claim 1, wherein the delicate material is selected from the group consisting of: embroidery, brocade, crochet, netting, fishnet, mesh, tissue paper, sequins, beads, and filigree.

4. The reusable masquerade of claim 1, wherein the flexible backing is vinyl.

5. The reusable masquerade of claim 1, wherein the flexible backing is selected from the group consisting of: rubber and plastic.

6. The reusable masquerade of claim 1, wherein the flexible backing is transparent.

7. The reusable masquerade of claim 1, wherein the flexible backing is translucent.

8. The reusable masquerade of claim 2, wherein the flexible backing is transparent vinyl.

9. The reusable masquerade of claim 1, wherein the flexible backing is configured to adhere to skin through spirit gum and yet the spirit gum can be easily removed from the flexible backing with soap and water or a makeup remover.

10. The reusable masquerade of claim 1, wherein the flexible backing adheres to the delicate material by ironing the flexible backing onto the delicate material.

11. The reusable masquerade of claim 1, wherein the flexible backing has a thickness that is less than 25% of the thickness of the delicate material.

12. The reusable masquerade of claim 1, wherein the masquerade has a hole in it sized and configured to fit over a person's eye and an outer periphery of the masquerade is sized and configured for placement on a person's face around the eye.

13. The reusable masquerade of claim 8, wherein the masquerade has a hole in it sized and configured to fit over a person's eye and an outer periphery of the masquerade is sized and configured for placement on a person's face around the eye.

14. A method of making the reusable masquerade of claim 1, comprising:
positioning a material that will be used for the flexible backing adjacent the delicate material;
adhering the flexible backing to the delicate material; and
cutting the delicate material and attached flexible backing in a manner that at least partially conforms to a design on the delicate material.

15. The method of claim 14, wherein the positioning step involves laying the material that will be used for the flexible backing over the delicate material.

16. The method of claim 14, wherein the adhering step involves heating the material that will be used for the flexible backing while it is adjacent the delicate material.

17. The method of claim 14, wherein the adhering step involves ironing the material that will be used for the flexible backing onto the delicate material.

18. A method of attaching the reusable masquerade of claim 1 to skin, comprising:
applying spirit gum to a surface of the flexible backing;
joining the surface of the flexible backing with the spirit gum on it to the skin;
and applying pressure to a surface of the delicate material.

19. A method of attaching the reusable masquerade of claim 1 to skin, comprising:
applying spirit gum to a skin surface; and
attaching a surface of the flexible backing to the skin surface with the spirit gum on it; and
applying pressure to a surface of the delicate material.
